(19) United States
(12) Patent Application Publication
(10) Pub. No.: US 2026/0081391 A1
(43) Pub. Date: Mar. 19, 2026

(54) HIGH-SPEED, HERMAPHRODITIC CONNECTOR AND CONNECTOR ASSEMBLIES

(71) Applicant: Molex, LLC, Lisle, IL (US)

(72) Inventors: John C. Laurx, Aurora, IL (US); Khang Choong Yong, Singapore (SG); Michael D. Rost, Taipei City (TW); Pue Xie, Naerville, IL (US)

(21) Appl. No.: 19/399,091

(22) Filed: Nov. 24, 2025

Related U.S. Application Data
(63) Continuation of application No. 18/031,890, now Pat. No. 12,506,307.
(60) Provisional application No. 63/123,486, filed on Dec. 10, 2020.

(51) Int. Cl. H01R 24/84; H01R 13/28; H01R 13/631; H01R 13/64; H01R 13/6592

(52) U.S. Cl. CPC H01R 24/84; H01R 13/28; H01R 13/631; H01R 13/64; H01R 13/6592

(57) ABSTRACT

High-speed, hermaphroditic electrical connectors may be connected to form a hermaphroditic connector assembly that uses less space than existing connector assemblies. A housing can provide a first and second engagement feature that are intended to engage each other so that when two such connectors are rotated 180 degrees the engagement features allow two such connectors to mate together. Cables can be connected directly to the terminals so as to provide for improved electrical performance.

### TECHNICAL FIELD

This disclosure relates to the field of connectors, more specifically to hermaphroditic connectors and assemblies suitable for use in high-data rate applications.

### INTRODUCTION

Evolving telecommunication systems and network architectures desire electronic chip-to-chip interconnections that are capable of supporting higher density and higher bandwidths (while meeting signal integrity requirements) with increased flexibility and lower cost. Existing copper-based interconnections (e.g., connectors) sometimes suffer from substantial printed circuit board (PCB) signal losses (e.g., when electrical signals must travel over traces embedded in a PCB or similar substrate. Accordingly, it is desirable to provide connectors that address the shortcomings of existing interconnections.

### SUMMARY

In an embodiment, one or more hermaphroditic connectors may be provided to address and overcome some of the shortcomings of existing connectors, where two such hermaphroditic connectors may be connected to form a hermaphroditic connector assembly.

In more detail, a first connector may comprise a first housing configured to receive a plurality of wafers, with each wafer supporting a plurality of cables. Further, the first connector may comprise a first and second engagement feature, where the first engagement feature is configured to mate with the second engagement feature. In an embodiment, a first connector may be configured to mate with a second connector that is substantially the same as the first connector but with the orientation of the first connector being 180 degrees different than the second connector. In an embodiment, the first engagement feature may be configured as a T-shaped rib while the second engagement feature may be configured as a T-shaped, slot.

The housing may further comprise additional engagement features to hold the first and second connectors together, it being understood that additional engagement features will typically be added in pairs so that, for example, a third engagement feature can engage a fourth engagement feature when the first and second connectors are mated together. In on embodiment, the third engagement feature will be a shroud and the fourth engagement feature will insert into the shroud.

The exemplary first connector may further comprise one or more shields, each shield configured as an electrical ground and may be further configured to electromagnetically protect high-speed, differential electrical signals being transmitted by terminals. Each of the one or more shields of the first connector may be further configured to structurally support the terminals.

In an embodiment, each of the one or more shields of the first connector: (i) may be configured as a U-shaped shield; (ii) may comprise an opening for receiving solder or another connection material to connect a grounding structure (e.g., a flat drain foil) of a cable (e.g., twinax cable) to a respective shield to form a ground path; (iii) may comprise one or more openings, each opening configured to receive a protrusion of a dielectric component to connect the dielectric component to a respective shield; and (iv) may comprise an electromagnetically shielded and electrically grounded wall and electromagnetically shielded and electrically grounded sidewalls, wherein the sidewalls of a respective shield comprise ends configured to electrically connect a grounding structure of a cable to the respective shield, and wherein the ends of a respective shield may be configured inwardly towards the grounding structure of the cable to provide a surface at which a respective shield is electrically bonded to the grounding structure of the cable and to protect the connection of an electrically conductive tail and conductor from unwanted electromagnetic signals, In an embodiment, the first connector may further comprise one or more electrical grounding collars, each collar configured to connect to a grounding structure of a cable and to ends of a respective shield to form a ground path. Such a grounding collar may be a separate component or may be integral with a shield to connect a respective shield to a grounding structure of the cable, forming a ground path.

In another embodiment, the first connector may further comprise one or more electrical grounding collars, each collar configured to be connected to a respective shield of the first connector and to a grounding structure (e.g., flat drain foil) of a cable. Each collar may be further configured to provide an electromagnetic, protective canopy over a connection of respective conductive, electronic tails to conductors of the cable (“conductors” for short) to reduce unwanted crosstalk and control an impedance of the connection. Each collar may comprise one or more integral, indentations and the respective shield may comprise one or more integral, inward protrusions to connect the collar to the shield.

In still another embodiment, each of the one or more shields of a first connector may comprise retaining arms that may be configured to contact dual, side ground drain wires of a cable to form a ground path.

Alternatively, each of the shields may comprise an opening to provide access to the conductor termination to the tails of the contacts. In such an embodiment, a first connector may further comprise one or more conductive, micro-clamps (e.g., composed of a conductive plated plastic), each micro-clamp positioned over an opening in an adjacent shield to reduce or mitigate unwanted cross-talk therebetween. Each of the micro-clamps may be configured to compress dual, side ground drain wires of a cable onto integral tabs of one of the one or more shields to form a ground path. Optionally, each of the micro-clamps may comprise a latch mechanism to allow respective, connected tails and respective, conductors to be accessed, for example. In some embodiments a micro-clamp can be configured to extend across and engage multiple shields.

In addition to shields, each of the one or more hermaphroditic connectors (e.g., the first connector) may further comprise conductive structures, where each conductive structure may comprise a respective internal conductor on one end and a respective electrically conductive tail on an opposite end, where each respective internal conductor may comprise an end formed to apply a frictional force when the conductor contacts an internal conductor of the second hermaphroditic connector to form connected, high-speed signal paths.

Each of the one or more shields of the first connector may comprise a main wall, sidewalls, ends or spring fingers that may make contact with a recess in a shield of the second connector to form an electrical ground path between the first and second connectors and to protect a connection between the first and second connector from unwanted electromagnetic signals.

In an embodiment, the housing mentioned previously may comprise a plurality of pockets, each pocket configured to hold and support one of the one or more shields and terminals, and wherein each pocket may be further configured to provide open space, filled with air, that functions as a way to lower the dielectric constant to reduce potential crosstalk between adjacent terminals. The pockets can be provided in a row in the housing.

In further embodiments, each of the one or more shields may comprise flexible, conductive fingers that may electromagnetically shield at least terminals and may be configured as an electrical ground.

In an embodiment, each tail of a conductive structure may be configured to connect to a conductor to enable transmission of high-speed electrical signals (e.g., 112 Gbps, or between 112 Gbps and 224 Gbps). Further, each of the tails may be configured with one or more undulated edges comprising one or more dentations, where (i) a width of each tail may vary along a connected length where a tail is connected to a conductor to control an impedance of the connection of the tail and conductor and to avoid unwanted electrical crosstalk; (ii) each tail may comprise one or more peak portions and one or more valley portions to connect the tail to the conductor; (iii) a width of a valley portion may differ from one valley portion to another valley portion and a width of a peak portion may vary from one peak portion to another peak portion by 10% or 20%; and (iv) each undulated edge may be rounded, rectangular, diamond-shaped, or another shape that improves the connection of a respective tail to a respective conductor. Still further, one or more of the peak portions may be configured to guide a conductor onto a tail. In more detail, one or more of the peak portions may be configured as a hook to guide the conductor onto the tail.

It should be understood that the first connector may be connected to the second hermaphroditic connector, wherein the connected first and second hermaphroditic connectors may comprise a hermaphroditic connector assembly.

### BRIEF DESCRIPTION OF THE DRAWINGS

The present disclosure is illustrated by way of example and not limited to the accompanying figures in which like reference numerals may refer to similar elements and in which:

FIG. 1 illustrates an isometric view of an exemplary hermaphroditic, high density, high bandwidth connector system in an unmated condition;

FIG. 2 illustrates another isometric view of the embodiment depicted in FIG. 1;

FIG. 3 illustrates another isometric view of the connector system depicted in FIG. 1;

FIG. 4 illustrates another isometric view of the connector system depicted in FIG. 1;

FIG. 5 depicts an isometric view of the connector system depicted in FIG. 1 but with in a mated condition;

FIG. 6 illustrates two exemplary hermaphroditic, high density, high bandwidth connectors that may be configured to form an exemplary connector assembly;

FIG. 7 depicts an isometric cross-sectional view of an exemplary hermaphroditic connector;

FIG. 8 depicts a simplified isometric view of a housing of an exemplary hermaphroditic connector;

FIG. 9 depicts an isometric cross-sectional view of the connection of exemplary hermaphroditic connectors;

FIGS. 10 and 11 depict enlarged isometric views of an exemplary shield and some of the components protected and supported by the shield;

FIG. 12 illustrates an isometric simplified view of the exemplary connection of tails to conductors (e.g., high-speed, (112 gigabits per second (Gbps) to 224 Gbps) differential twinax conductors) of a cable;

FIG. 13 illustrates another isometric view of the embodiment depicted in FIG. 12;

FIG. 14 illustrates an example of how an shield may support the embodiment depicted inf FIG. 13, among other features;

FIG. 15 depicts an isometric view of tails connected to conductors of a twin-ax cable in combination with an embodiment of a shield;

FIG. 16 illustrates a simplified isometric view of an alternative embodiment of a structure that can be used to connect to a shielding layer on a twin-ax cable;

FIG. 17 illustrates an isometric view of the structure depicted in FIG. 16 showing an embodiment of a cable to terminal arrangement;

FIG. 18 illustrates an embodiment of the shield and chicklet;

FIGS. 19 to 22 depict embodiments that illustrate additional, alternative structures and methods for connecting a shield to a cable (e.g., twinax cable);

FIGS. 23 to 25 depict the exemplary connection of dual side drain wires of an electrical cable to a shield;

FIGS. 26 to 29 depict embodiments for connecting a cable (e.g., twinax cable) to a shield and tails;

FIG. 30 depicts an enlarged view of an exemplary connection of a cable (e.g., twinax cable) to a shield and tails;

FIG. 31 depicts an exemplary tail with a portion shaped to, among other things, guide a conductor of a cable onto the surface of the tail; and

FIGS. 32 to 34 illustrate exemplary views of an exemplary connection of terminals of one connector to terminals of another connector.

### DETAILED DESCRIPTION

Simplicity and clarity in both illustration and description are sought to effectively enable a person of skill in the art to make, use, and best practice embodiments disclosed herein in view of what is already known in the art. One skilled in the art will appreciate that various modifications and changes may be made to the specific embodiments described herein without departing from the spirit and scope of the disclosure. Thus, the specification and drawings are to be regarded as illustrative and exemplary rather than restrictive or all-encompassing, and all such modifications to the specific embodiments described herein are intended to be included within the scope of the disclosure. Yet further, unless otherwise noted, features disclosed herein may be combined together to form additional combinations that were not otherwise described or shown for purposes of brevity.

It should also be noted that one or more exemplary embodiments may be described as a method or process. Although a method or process may be described as an exemplary sequence (i.e., sequential), unless otherwise noted the steps in the sequence may also be performed in parallel, concurrently or simultaneously. In addition, the order of each formative step within a method or process may be re-arranged. A described method or process may be terminated when completed, and may also include additional steps that are not described herein if, for example, such steps are known by those skilled in the art.

As used herein the terms “high-speed” and “high-data rate” may be used interchangeably. As used herein, the term “embodiment” or “exemplary” mean an example that falls within the scope of the disclosure. Substantially similar, when referring to a first and second connector, means that both connectors are close enough to being identical so as to allow each other to mate together and form a hermaphroditic connector assembly.

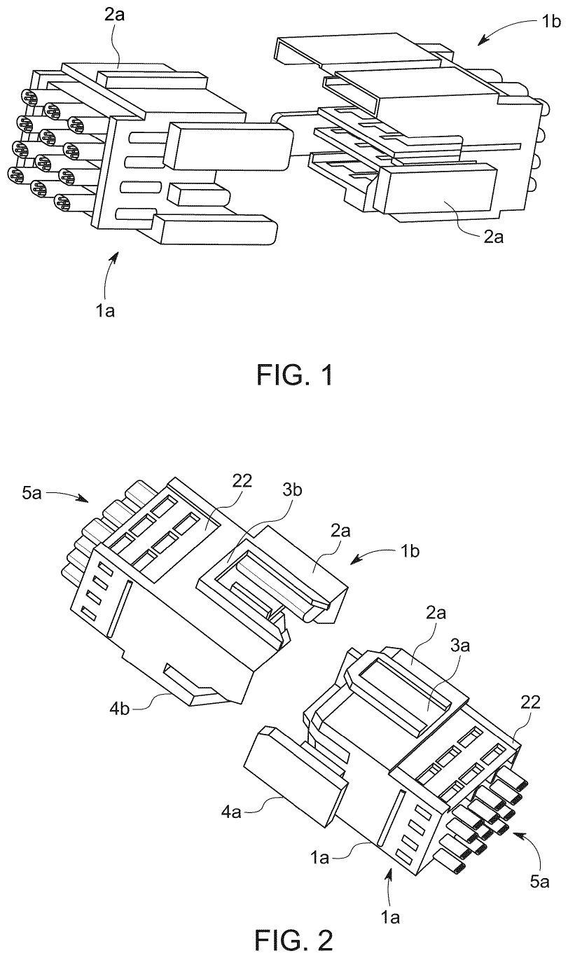

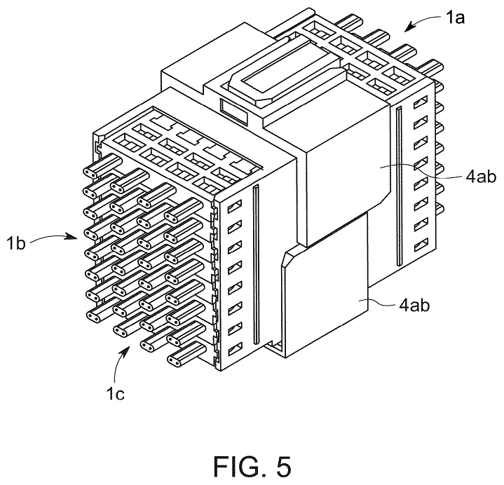

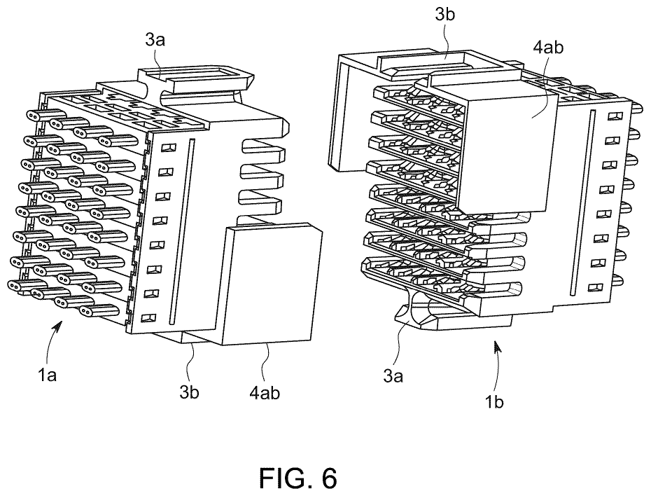

FIGS. 1 to 6 illustrate embodiments of exemplary hermaphroditic connectors 1a and 1b that may, among other things, provide increased flexibility and lower cost when compared to existing connectors, while also potentially increasing density and supporting higher data rates. When connected together, the two connectors 1a and 1b may be referred to as a hermaphroditic connector assembly 1c, for example (see FIG. 5). As shown, each connector 1a, 1b is substantially the same and may comprise a respective housing 2a that can be formed of an insulative material configured to receive a plurality of electrical or electronic, conductive cables 5a (e.g., twinax cables) and to connect each cable to enclosed and protected internal conductive components. Though each connector 1a, 1b is shown as receiving respective electrical cables 5a, the tails that will be discussed below could be amended to terminate into a substrate rather than terminate to conductors in cables. Said another way, FIGS. 1 to 4 illustrate embodiments of the connector system connected to cables.

As can be appreciated, each of the connectors 1a, 1b supports a plurality of wafers 22 that are inserted into the housing 2a. The wafers 22 can be formed by overmolding a portion of one or more cables 5a and an associated shield/terminal so to support the components within the housing 2a and to provide strain relief for the cables 5a. It should be noted that while the cables for both connectors can be the same, such uniform construction of the cables is not required and different cables can be used for both connectors, as desired.

For ease of reference cables received by connector 1a may be referred to herein as a “first” plurality of cables while cables received by connector 1b 5b may be referred to herein as a “second” plurality of cables.

Each connector 1a, 1b may comprise one or more, respective, engagement features formed as a part of (i.e., integral to) a respective housing 2a. FIG. 1 illustrates a first embodiment that includes a simple protrusion and corresponding slot while FIGS. 2-6 illustrate a second embodiment. Though using one first engagement feature and one second engagement feature for each housing is depicted, it should be understood that this is exemplary and additional engagement features can be provided as desired. In more detail, in one embodiment the housing 2a of connector 1a (sometimes referred to as a “first” housing) may comprise a first engagement feature 3a that may be configured to be mate with a corresponding second engagement feature 3b of housing 2a of the connector 1b (sometimes referred to as a “second” housing). Further, a second engagement feature 4a of connector 1a may be configured to be shaped to mate with the first engagement feature 4b of connector 1b (see FIGS. 2-6). The combination of engagement features 4a and 4b can collectively provide an engagement arrangement 4ab that allows the mated connector to provide a shroud around the contact area. As can be appreciated, therefore, each connector can have a first engagement feature and a second engagement feature that are configured to respectively engage the second and first engagement features of a mating connector.

As shown in FIGS. 1 to 6 the first engagement features 3a may be configured as “T” shaped ribs while the second engagement features 3b may be configured as “T” shaped slots, for example. It should be understood, however, that the T shaped rib and slot are merely illustrative and other shapes may be used to align and connect one connector to another. In an embodiment, to align and connect the connectors 1a, 1b, a respective T-shaped rib 3a may be inserted into a respective T-shaped slot 3b.

Further, the respective ribs and slots also align respective terminals 7a of respective connectors 1a, 1b in order to allow high-speed electrical signals (e.g., 112 Gbps) to be transported or conducted from cable to cable, as will be described in more detail elsewhere herein. As can be appreciated, for each connector, the first and second engagement features may be positioned on opposite sides of the respective connector so that two such connectors can mate with each other when properly orientated.

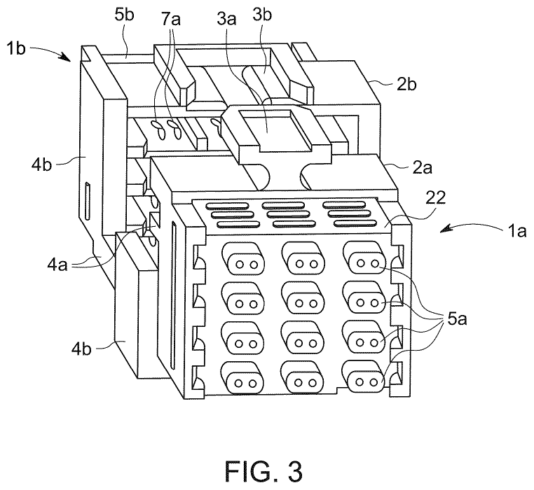

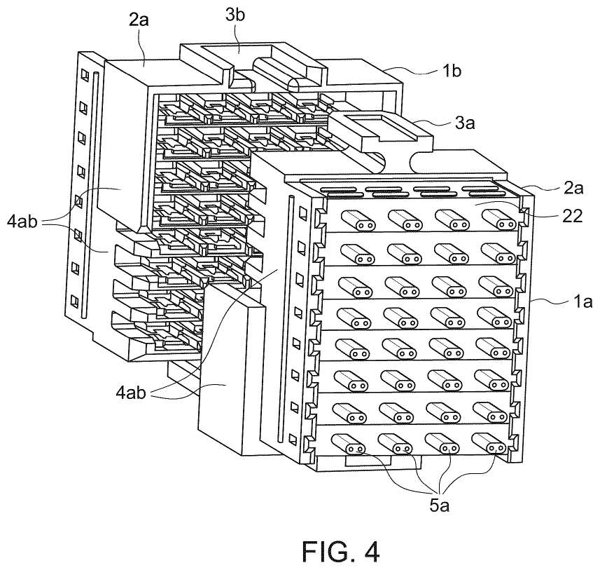

Because each connector 1a, 1b has both first and second engagement features and two such connectors can be mated together, such connectors may be referred to as hermaphroditic connectors. FIGS. 3 and 4 also show additional engagement features 4a, 4b that collectively form engagement feature set 4ab that may be integral with a respective housing 2a and help align and control mating of two connectors. As can be appreciated from FIG. 4, both connectors can be identical but merely rotated 180 degrees so that that they can mate to each other.

As depicted, the engagement features 4a, 4b are provided on opposite sides so that when two connectors are mated together, a completely protected mating interface can be provided. Thus, the engagement feature 4a may fit into the engagement feature 4b.

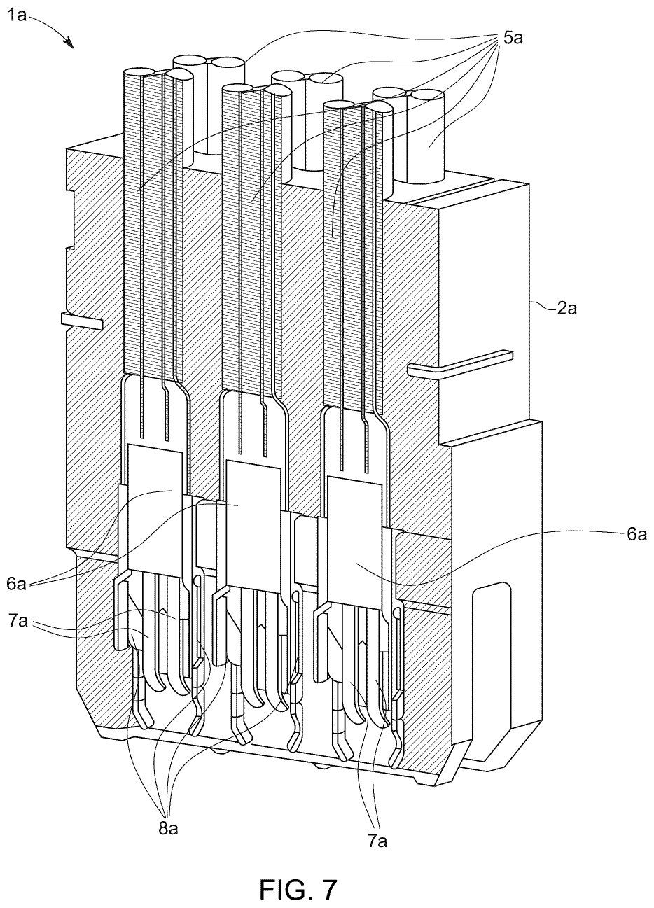

Referring to FIG. 7. there is depicted an exemplary cross-sectional view of a section of the exemplary connector 1a. From this view it can be seen that each exemplary connector may comprise one or more electrically grounded, shields 8a, which can be formed of a desirable alloy, often copper-based, where each shield 8a is configured to function as an electrical ground to provide a ground path for common mode energy and is further configured to shield the high-speed differential signals being transmitted by corresponding internal, terminals 7a within each shield 8a from unwanted electromagnetic signals (e.g., radio frequency (RF) signals). Still further, each shield 8a may additionally be configured to structurally support respective terminals 7a and chicklet 6a that may be positioned within the walls of each shield 8a.

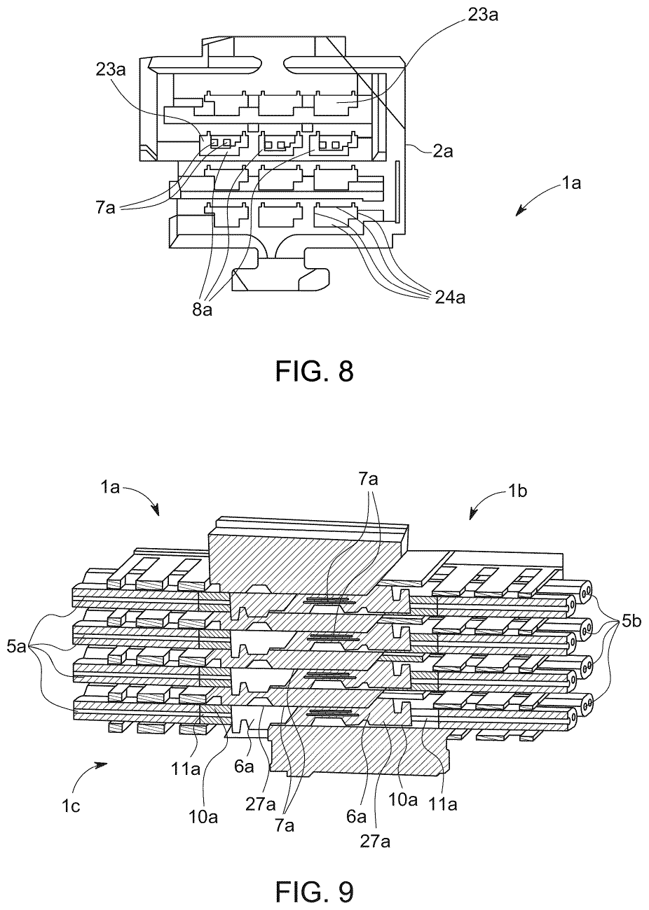

Referring now to FIG. 8 there is depicted a simplified view of a plurality of respective shields 8a and their respective terminals 7a, each positioned within one of a plurality of respective openings or “pockets” 23a formed by respective walls 24a (e.g., four walls) of housing 2a. As shown the housing 2a may comprise a plurality of pockets 23a, each pocket configured to hold and support a respective shield 8a and terminals 7a, for example, and the pockets 23a can be aligned in one or more rows with each row in the housing configured to accept the wafer 22.

In an embodiment, a set of walls 24a may support and align a respective shield 8a and terminals 7a and separate each of the respective shields 8a and conductors 7a from other shields and conductors of the same connector 1a, for example. Further, in an embodiment, each formed pocket 23a may be configured to provide a region of air on one or more sides of the shield and the region of air can help modify the dielectric constant of the connector system to help improve signal integrity.

FIG. 9 depicts a simplified cross-sectional view of the connection of connectors 1a, 1b illustrating, among other things, that each respective connector 1a, 1b may be configured with pairs of terminals 7a which can be identical but in opposite orientation in each connector so that they can be mated together. As can be appreciated, each tail 10a on an end of the terminals 7a. In embodiments, each respective tail 10a of connector 1a may be connected to an conductor 11a of a cable 5a (hereafter “cable” conductor) that may transport a high-speed differential signal and each respective tail 10b of connector 1b may be connected to a conductor 11b of cable 5b that may transport a high-speed differential signal, Further, a respective terminal 7a of connector 1a may be connected to a respective terminal 7a of connector 1b when the connectors 1a, 1b are so connected to form a hermaphroditic assembly 1c.

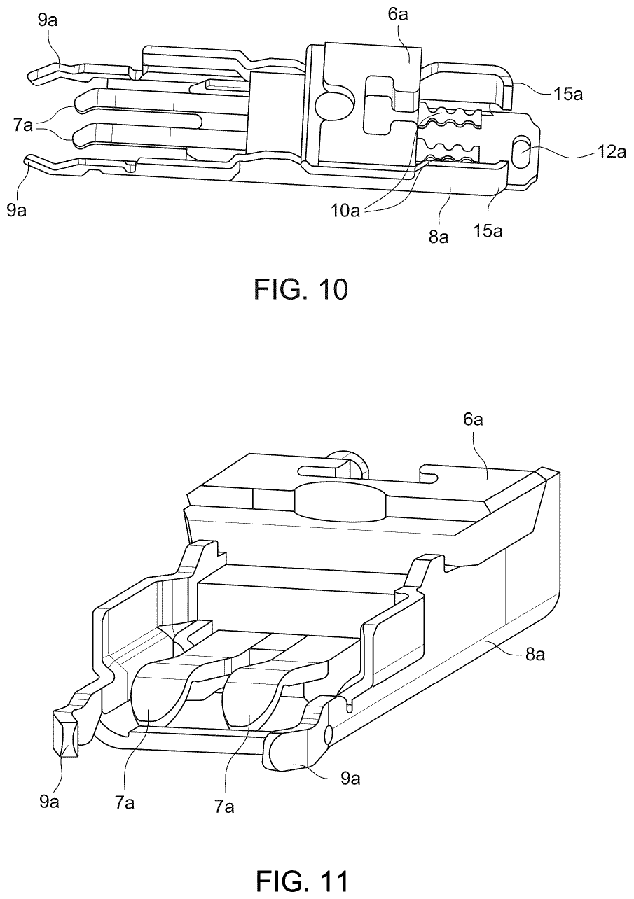

Referring now to FIGS. 10 and 11 there is depicted enlarged views of an exemplary shield 8a and the components it may protect and support. In an embodiment, each shield 8a of connector 1a may be configured as a U-shaped shield to help support and protect the respective terminals 7a and chicklet 6a.

In an embodiment, the terminals 7a may be supported by the respective shield 8a by mounting the chicklet 6a (which can also be referred to as a terminal housing 6a) to the shield 8a. Further, each terminal 7a may comprise a contact portion with end that is formed in an “elbow” shape (i.e., bent) in order to allow mating terminals 7a to engage each other without stubbing and to form a connected, high-speed signal path.

Each shield 8a may comprise fingers 9a, which can be flexible and can help shield at least conductors 7a when a connection is formed when the conductors 7a of one connector (e.g., connector 1a) are positioned to make physical contact with conductors (e.g., conductors 7b) of another connector (e.g., connector 1b; see FIGS. 9 and 32 to 34). The fingers 9a may also be configured as an electrical grounding structure to provide a grounding path (see FIG. 33). For example, in an embodiment, the respective fingers 9a of connector 1a may comprise flexible structures configured to make contact with the recess 29 of the shield 8a in a mating connector (e.g., connector 1b) to form (and maintain) an electrical grounding path (see FIGS. 33 and 34). Such a connection may occur when connector 1a is connected to connector 1b to form a hermaphroditic assembly 1c (see FIGS. 5 and 9, for example).

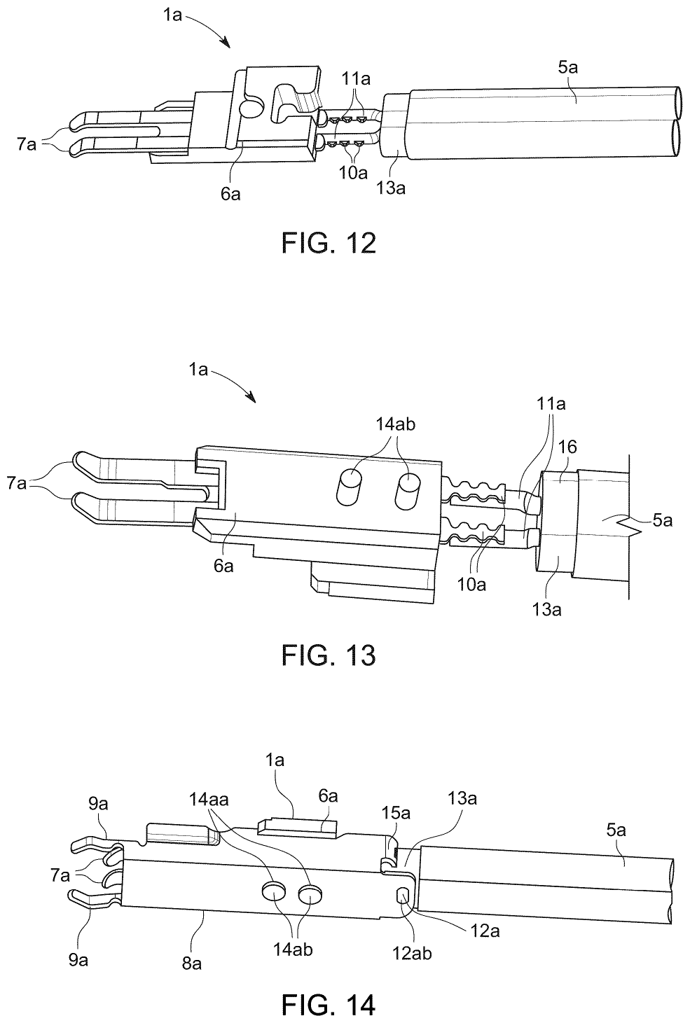

FIGS. 12 and 13 depict simplified views of the connection of one set of exemplary tails 10a of connector 1a to one set of conductors 11a (e.g., high-speed, differential twinax conductors) of cable 5a. FIG. 12 depicts a top view of such connections and FIG. 13 depicts a bottom view of the same connections. In both FIGS. 12 and 13 the shield 8a (that may protect the internal terminals 7a, chicklet 6a, and the connection between tails 10a and conductor 11a) is not shown to allow the reader to see the internal features, though it should be understood that a shield 8a is utilized in these embodiments (see FIG. 14). As shown, tails 10a may be positioned on an opposite end of the shield 8a from the terminals 7a. As can be further appreciated, the cable 5a includes a shielding layer 13a and a flat drain wire 16, it being understood that other configurations of twin-ax cable can be used and are discussed below.

Though only one shield 8a, one set of terminals 7a and one cable 5a comprising conductors 11a are shown, it should be understood that each shield 8a, each terminals 7a and each cable 5a/conductor 11a making up, or connected to, connector 1a may be illustrated in a similar fashion.

Continuing, in an embodiment an exemplary cable 5a may form a connection with connector 1a to transport high-speed, differential signals when its respective conductors 11a are connected to respective tails 10a of connector 1a by a welding process, for example. In an embodiment, one conductor 11a may be overlapped and connected to one tail 10a (or-vice versa), for example, to insure the high-speed electrical signals transported on conductors 11a (e.g., 112 Gbps signals, signals between 112 Gbps and 224 Gbps) may continue to be transported through tails 10a and, eventually on to terminals 7a. As noted previously, each conductive tail 10a of connector 1a may be one end of a conductive structure 27a that also comprises an internal conductor 7a (see FIG. 9).

In addition to connecting the differential, high-speed signal conductors 11a to tails 10a of connector 1a, a shielding layer of the cable 5a may also be connected to the connector 1a. For example, referring to FIG. 14 there is depicted a shield 8a that may comprise an opening 12a for receiving solder or another connection material 12ab to connect the shielding layer 13a and the drain wire 16 of a cable 5a (e.g., a differential, high-speed signal cable) to the shield 8a to form a ground path and electrically connect the drain wire, the shield and the shielding layer together.

FIG. 14 also illustrates an example of how an exemplary shield 8a may support the chicklet 6a. In an embodiment, the shield 8a may comprise one or more openings 14aa, each opening configured to receive a protrusion 14ab of the chicklet 6a in order to connect the chicklet 6a to the shield 8a, thereby fixing the chicklet 6a to the shield 8a in order to provide structural support and stability to the chicklet 6a.

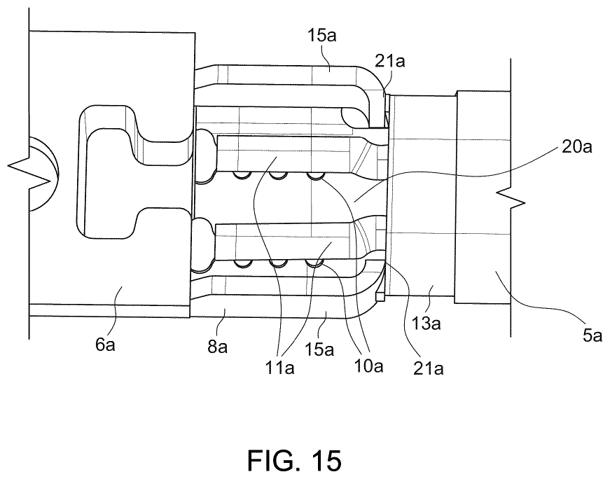

FIG. 15 depicts an enlarged view of a connection of exemplary tails 10a to conductors 11a. As shown, the overlapped, connected tails 10a and conductors 11a may be positioned within a main wall 20a (shown underneath conductors 11a in FIG. 15) and sidewalls 15a of shield 8a.

In the embodiment depicted in FIG. 15 the sidewalls 15a may include respective ends 21a configured to electrically connect the shieling layer 13a of cable 5a to the shield 8a. Further, the ends 21a may be configured inwardly (i.e., bent towards the shielding layer 13a of the cable 5a) though this is merely exemplary. The inwardly formed ends 21a of sidewalls 15a may provide surfaces (troughs) at which the shield 8a may be electrically bonded (e.g., via solder or conductive adhesive) to the shielding layer 13a of the cable 5a. Such a configuration allows the sidewalls 15a and wall 20a to help provide a transition from the common mode coupling between the conductors 10a and the shielding layer 13a to the common mode coupling between the terminals 7a and the shield 8a while also providing shielding to reduce potential crosstalk from adjacent terminals.

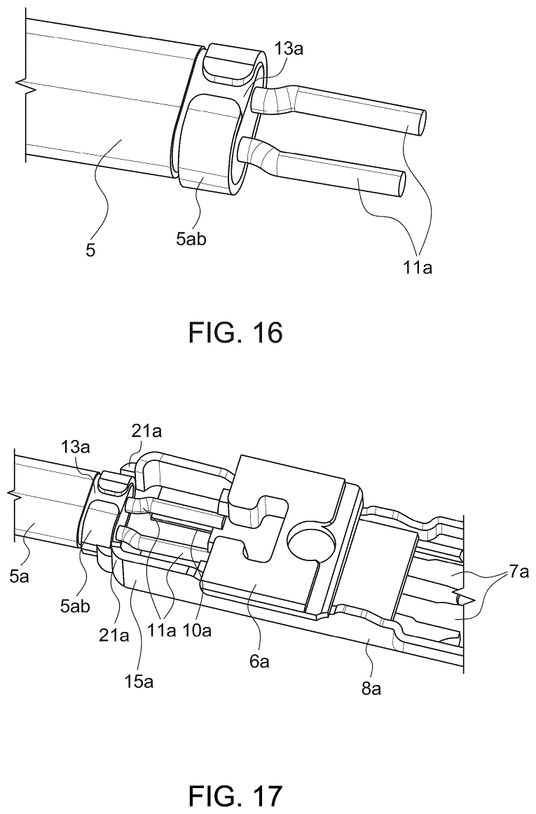

Referring now to FIGS. 16 to 18 there are depicted embodiments that illustrate alternative structures and methods for connecting a shield to a conductor of a cable (e.g., twinax cable) and vice-versa. As shown in FIG. 16, an electrical, conductive grounding collar 5ab may be attached (e.g., crimped, soldered, connected with a conductive adhesive) to the shielding layer 13a and the drain wire 16 of the cable 5a. Thereafter, the inward ends 21a of sidewalls 15a of shield 8a may be connected (e.g., welded, soldered) to the collar 5ab to form a ground path connection (see FIG. 17).

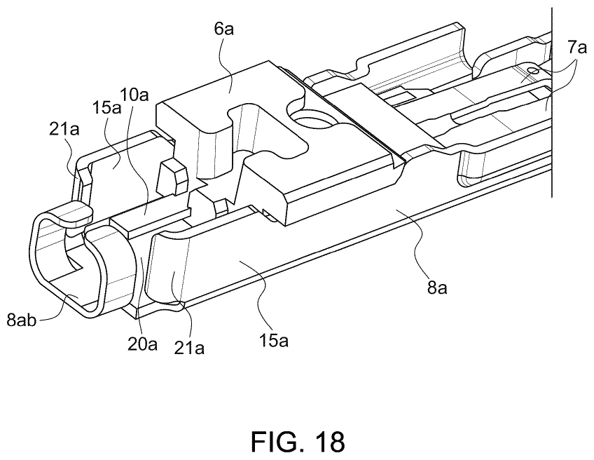

In FIGS. 16 and 17 the collar 5ab is illustrated as a separate component. However, in yet another embodiment a collar may be formed as an integral part of a shield. For example, in FIG. 18 a collar 8ab is depicted as an integral part of shield 8a, for example. The collar 8ab of shield 8a may be connected (e.g., welded, soldered) to the shielding layer 13a of cable 5a to form a ground path connection. The collar 8ab can also engage the drain wire 16.

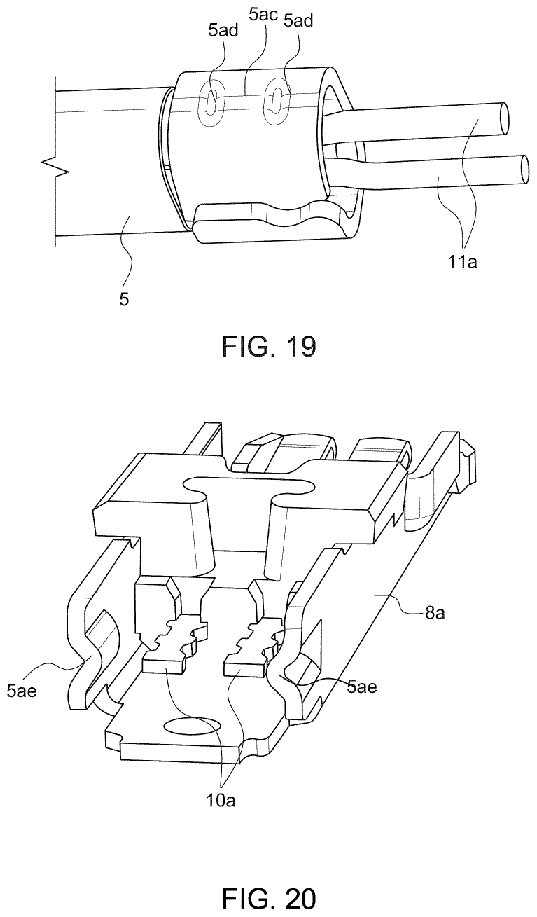

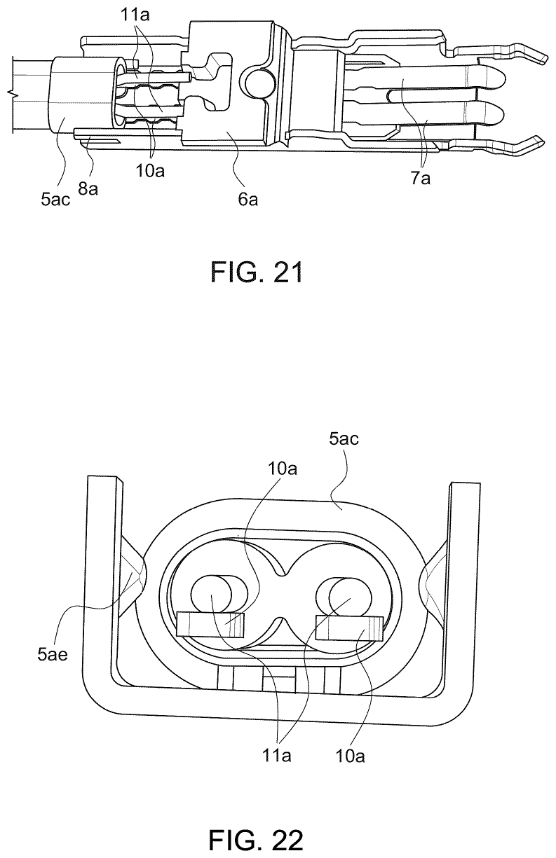

Referring now to FIGS. 19 to 22 there are depicted embodiments that illustrate additional, alternative structures and methods for connecting a shield to a cable (e.g., twinax cable). As shown in FIG. 19, an electrical grounding collar 5ac may be connected (e.g., crimped, soldered, connected with a conductive adhesive) to the shield layer 13a of a cable 5a. Further, in an embodiment, to connect the collar 5ac to an exemplary shield 8a to complete a grounding path, one or more sets of mated inward protrusions and inward indentations may be used, for example. In the embodiments depicted in FIGS. 19 to 22 the collar 5ac may comprise one or more integral indentations 5ad while the shield 8a may comprise one or more integral inward protrusions 5ae, for example, it being understood that this is merely exemplary (e.g., the protrusions may be outward and integral to the collar and the indentations may be outward and integral to the shield). Accordingly, the shield 8a may be connected to the collar 5ac by applying a force to the shield 8a or collar 5ac that forces each of the one or more protrusions 5ae into at least one of the one or more indentations 5ad (or vice-versa). Thereafter, additional connection methodologies may be used to further connect the collar 5ac to the shield 8a (e.g., soldering, laser welding, or mechanical crimping, conductive adhesive, etc.).

Compared to the collars 5ab, 8ab shown in FIGS. 16 to 18, the collar 5ac may have greater dimensions along its length, for example, than collars 5ab, 8ab in order to contact a conductor 11a over a longer length and larger area of conductor 11a. By doing so it is believed that the collar 5ac may more securely attach to the conductor 11a. Further, by configuring the collar 5ac with a longer length (along the axis of the conductor 11a) the collar 5ac may extend beyond the end of the conductor 11a (and its shielding layer 13a), thereby providing an electromagnetic, protective “canopy” over the overlapped connection of tails 10a to conductors 11a that may aid in the reduction of unwanted crosstalk and control the impedance of such a connection.

It is believed that the addition of either collars, 5ab, 8ab or 5ac may increase the structural rigidity of a termination of the cable to the terminals and may provide a favorable surface to help facilitate electrical connection to the shield 8a. It should be understood that when a cable (e.g., cables 5a or 5b) includes a different grounding structure than that shown in FIGS. 14 to 22, such a grounding structure may also be connected to an exemplary shield (e.g., shield 8a) of a connector to maintain an electrical ground path.

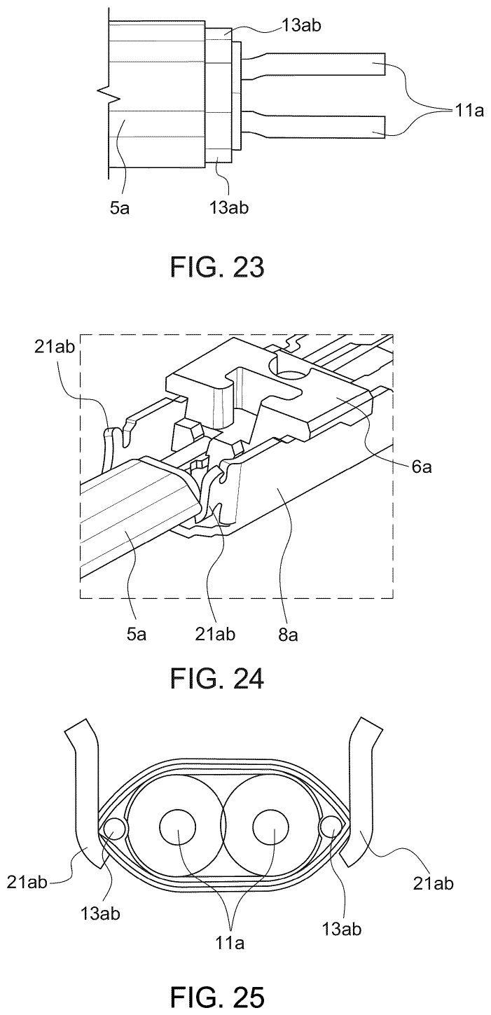

For example, referring now to FIGS. 23 to 25 there is shown an exemplary cable 5a with dual, side drain wires 13ab. In an embodiment, to electrically and physically connect an exemplary shield 8a to the drain wires 13ab, the shield 8a may include retaining arms 21ab, where the retaining arms 21ab may be configured as a cradle to make electrical and physical contact with the shield and/or exposed side drain ground wires 13ab, as shown in FIGS. 24 and 25. Though each retaining arm 21ab may make frictional contact with a drain wire 13ab to form a ground path connection between the shield 8a of connector 1a and cable 5a, such a connection may also include solder, laser welds or an adhesive coating to further fix the retaining arm 21ab to the corresponding drain wire 13ab.

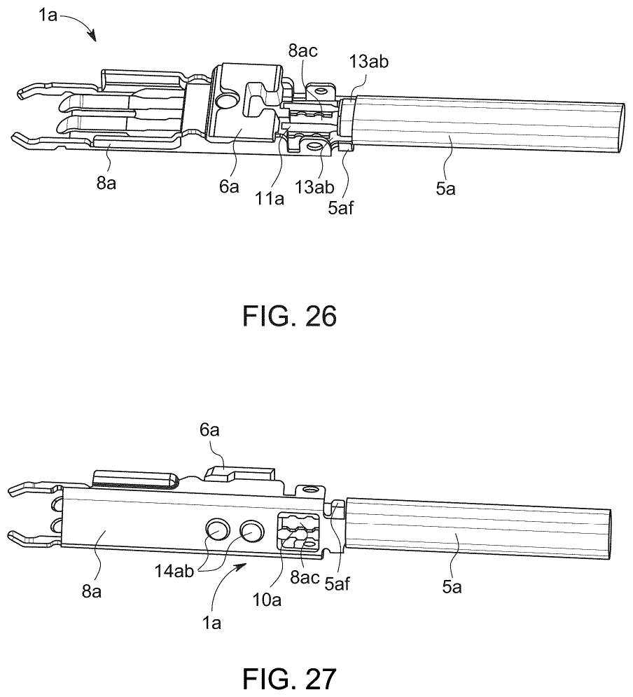

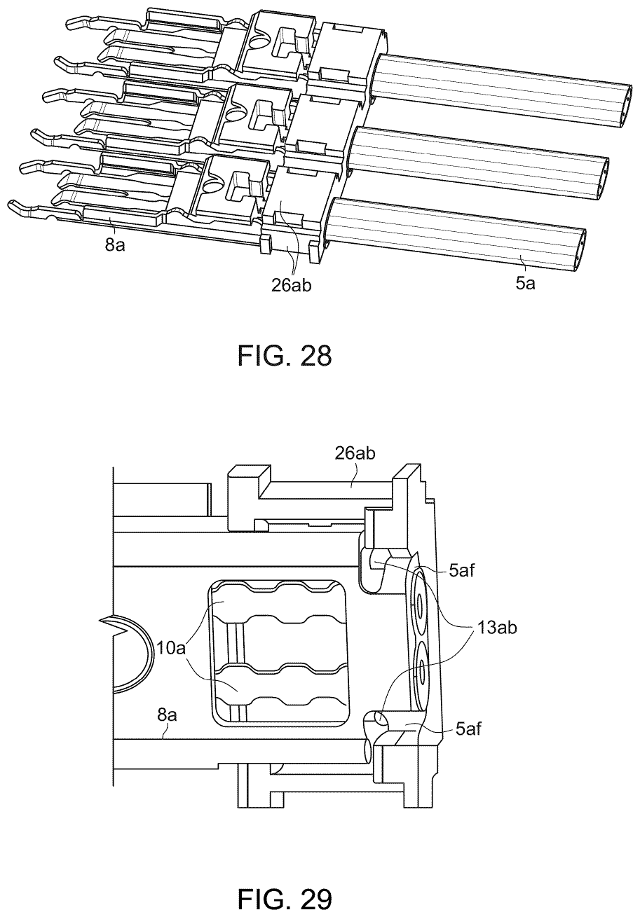

Yet another embodiment for connecting a cable (e.g., twinax cable) to terminals is shown in FIGS. 26 to 29. FIGS. 26 and 27 depict top and bottom views of an exemplary shield 8a and exemplary cable 5a with dual side drain wires 13ab. In an embodiment, to electrically connect tails 10a to conductors 11a of the cable 5a, an exemplary shield 8a may be configured with an opening 8ac. In an embodiment, the opening 8ac may allow the conductors 11a to be connected to the tails 10a using a resistance welding process, for example. However, the presence of an opening may increase unwanted cross-talk from an adjacent set of terminals. Accordingly, the inventors provide exemplary structures and techniques that may reduce unwanted cross-talk, as illustrated in FIGS. 28 and 29.

As shown, conductive, micro-clamp 26ab (made from a conductive plated plastic, for example) may be positioned over the connected tails 10a and conductors 11a (the later hidden from view) and when aligned with another shield 8a, the micro-clamp 26ab blocks the opening 8ac so as to reduce or mitigate the potential effects of unwanted cross-talk.

In FIG. 29 it can be seen that, in an embodiment, the micro-clamp 26ab may be configured to compress the drain wires 13ab onto integral tabs 5af of the grounded shield 8a, for example, to form a ground path.

In an embodiment, the micro-clamp 26ab may include a latch mechanism (not shown) to allow the connected tails 10a and conductors 11a to be accessed via the opening 8ac if need be. Further, the micro-clamp 26ab may be further secured to the connected tails and/or conductors during a wafer overmolding prices, for example. As can be appreciated, a plurality of micro-clamps can be provided as a single structure that spans across multiple shields.

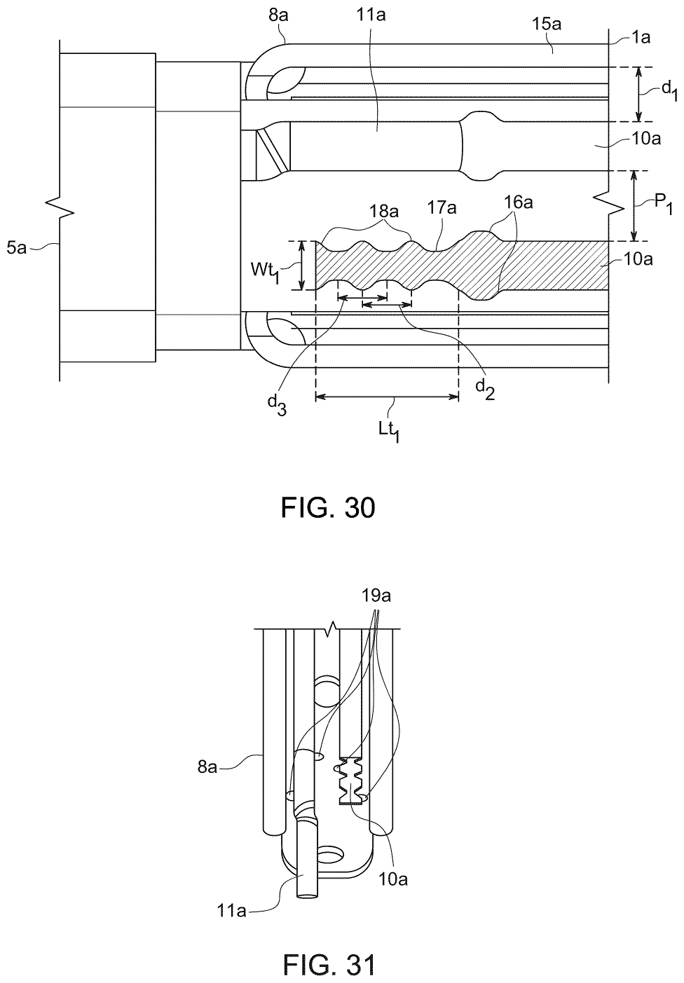

Referring now to FIG. 30, in an embodiment each exemplary tail 10a may be configured with one or more undulated edges comprising one or more indentations. As shown, exemplary tail 10a may comprise a plurality of undulated edges 16a, each edge having one or more indentations 17a. Accordingly, the width of the tail, wₜ₁, may vary along the connected length, lₜ₁, of the tail 10a (to provide a so-called “scalloped” tail). The inventors discovered that by varying the width of the tail 10a along its connected length lₜ₁, the impedance of the connection between the corresponding tail 10a and conductor 11a may be better controlled. This helps provide a more consistent impedance along the signal path and thus helps improve signal integrity of the system without the need to widen the distance d₁ between wall 15a of the shield 8a and tail 10a which may in turn widen the overall distance between opposing walls 15a of the shield 8a and, thus, disadvantageously enlarge the area encompassed by the connector 1a. Further, varying the width of a tail allows for additional surface area to ensure a reliable connection between the conductor and the tail. Though the scalloped tail 10a may comprise “valley” portions 17a (i.e., indentations) where its width is narrowed, it also comprises “peak” portions 18a where its width is wide enough to allow the tail 10a to be connected to the conductor 11a (e.g., via welding) to avoid problems associated with variations in the positioning of conductors 11a within cable 5a, for example.

In sum, it is believed that scalloped tails 10a provides sufficient electrical performance for the connection of a tail 10a and conductor 11a without sacrificing size (of connector 1a) or the mechanical integrity of the connection.

In embodiments, the minimum width of a valley portion 17a and/or of a peak portion 18a may depend on the width of a conductor 11a (i.e., wire gauge) that is to be connected (e.g., welded) to the tail 10a where the minimum width is about equal to or slightly less than the width of the conductor 11a.

While the tail 10a shown in the figures comprises the same, uniform width for each valley portion 17a and the same, uniform width for each peak portion 18a (though the widths of portions 17a and 18a differ), this is merely exemplary. Alternatively, the width of each valley portion 17a may differ from one portion 17a to another portion 17a. So too may the width of each peak portion 18a vary from one peak portion 18a to another peak portion 18a for a given tail 10a. For example, the width of the valley and/or peak portions of a given tail may increase or decrease from portion to portion along the connected length lₜ₁, of a tail (e.g., valley and/or peak portions may be wider the closer a portion is to a cable). Still further, the width of respective valley and peak portions may have varying, different widths form portion to portion along the connected length to reduce an impedance of a connection or to otherwise optimize the electrical and/or mechanical reliability of the connection.

Similarly, while the shape of the edges 16a of the peak portions 18a and valley portions 17a in the figures is rounded, this is also merely exemplary. Alternatively, the shape of the edges 16a of the valley and/or peak portions 17a, 18a may be rectangular, diamond-shaped, or another shape that improves the electrical and/or mechanical performance of the connection of a tail to a conductor.

In embodiments, length-wise distances d₂ and d₃ (i.e., separations), respectively, between the top of each peak portion 18a and between the bottom of each valley portion 17a, respectively, may be uniformly the same or may vary along the connected length. For example, a distance d₂, d₃ may gradually increase or decrease along the connected length. Still further a distance d₂, d₃ may vary from respective portion to respective portion (top of a peak portion 18a to top of another peak portion 18a, or bottom of a valley portion 17a to bottom of another valley portion 17a) along the connected length lₜ₁, of a tail (e.g., valley and/or peak portions may be wider the closer a portion is to a cable). Still further, the distance d₂, d₃ between respective tops and bottoms of respective valley and peak portions may vary from one portion to another portion along the connected length (i.e., dissimilar lengths between each top, peak portion and/or dissimilar lengths between each bottom, valley portion) to reduce an impedance of a connection or to otherwise optimize the electrical and/or mechanical reliability of the connection.

Yet further, one or more of the peak portions of a tail may be shaped or otherwise configured to guide a conductor onto the tail during a connection process. For example, referring to FIG. 31, there is depicted an exemplary tail 10a comprising a “hook”-shaped portion 19a that is configured to guide the conductor 11a onto the surface of the tail 10a so as to make alignment of the tail and the conductor easier to manage. Further, such a hook portion 19a may also aid in preventing the conductor 11a from moving during its connection to tail 10a (e.g., welds, overmolding), again resulting in a reliable connection.

Though the components (and their connections) of one connector 1a are depicted in FIGS. 9 to 31, it should be understood that connector 1b can have the same features as in most cases the connector 1b will be a duplicate of connector 1a but rotated 180 degrees. Accordingly, as previously indicated connectors 1a and 1b may be connected together to form a hermaphroditic connector assembly 1c.

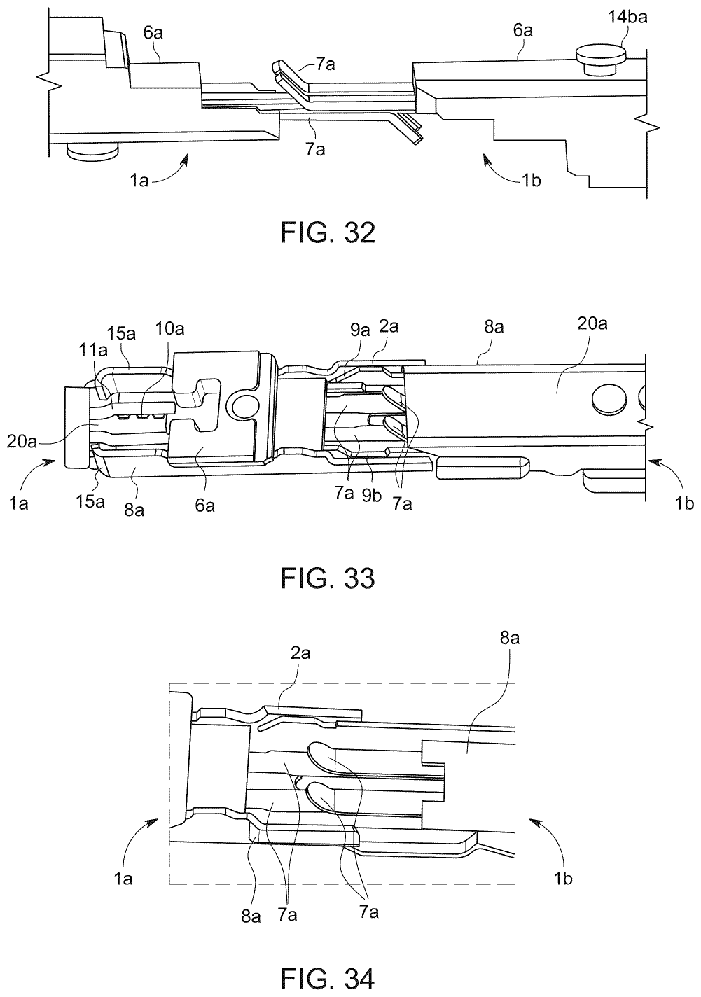

Referring now to FIGS. 32 to 34 there is depicted views of the exemplary connection of terminals 7a of a connector 1a to terminals 7a of a connector 1b and an exemplary connection of a shield 8a of connector 1a to a shield 8a of connector 1b. Although only one pairs of terminals 7a and one respective shield 8a of each respective connector 1a, 1b is shown it should be understood that additional terminals 7a and shields 8a of the connectors 1a, 1b may be connected in a similar fashion.

In FIG. 32 the shields 8a are not shown in order to illustrate how terminals 7a may contact one another to form connected, high-speed signal paths while in FIGS. 33 and 34 the shields 8a are shown. In FIG. 34 the shields are shown as being transparent though this is merely illustrative to allow the reader to once again see how the terminals 7a may contact with one another to form connected, high-speed signal paths.

In an embodiment, each of the respective terminals 7a of connector 1b may be overlappingly positioned on top of a terminals 7a of connector 1a (or vice-versa) as shown in FIGS. 32 to 34 to make physical and electrical contact with conductor 7a to form connected, high-speed signal paths. The depicted configuration can provide dual contact points and desirable levels of wipe without providing a large stub, which would be electrically undesirable.

As can be seen in FIG. 33, the conductors 11a may be positioned within the shield 8a, where each shield 8a may comprise a main wall, sidewalls, ends and/or arms that may make physical and electrical contact with each other at points 22, for example, to form (and maintain) an electrical ground path between connectors 1a, 1b, for example. The shields are thus configured to help control impedance of the connection, coupling between the signal and ground paths and protect the connection from unwanted electromagnetic signals from adjacent or nearby conductors (e.g., crosstalk), for example.

The inventors believe that connectors and connector assemblies described herein may use 75% or less of the space of existing connector/connector assemblies, for example, while enabling the transmission of high-speed, differential signals (e.g. 112 Gbps PAM4 capable and potentially 224 Gbps PAM4) without sacrificing electrical or mechanical performance (e.g., very low crosstalk, tight impedance control, low common mode conversion) and at a lower cost due to a reduction in tooling costs and fewer components versus existing connectors and connector assemblies.

While benefits, advantages, and solutions have been described above with regard to specific embodiments of the present invention, it should be understood that any component(s) that may cause or result in such benefits, advantages, or solutions to become more pronounced are not to be construed as a critical, required, or an essential feature or element of any or all the claims appended to the present disclosure or that result from the present disclosure.

Further, the disclosure provided herein describes features in terms of specific exemplary embodiments. However, numerous additional embodiments and modifications within the scope and spirit of the appended claims will occur to persons of ordinary skill in the art from a review of this disclosure and are intended to be covered by the disclosure and appended claims. Accordingly, this disclosure includes all such additional embodiments, modifications and equivalents of the subject matter recited in the claims appended hereto as permitted by applicable law. Moreover, any combination of the above-described components in all possible variations thereof is encompassed by the disclosure unless otherwise indicated herein or otherwise clearly contradicted by context.

We claim:

1. A system, comprising:
a first connector having a housing configured to couple to a second connector that is substantially similar to the first connector when the first connector is rotated relative to the second connector, wherein the housing comprises a plurality of terminals positioned in a plurality of conductive shields, each terminal among the plurality of terminals comprising a respective tail,
wherein each of the plurality of conductive shields comprises a U-shaped shield and a collar integral therewith that is configured to couple to a shielding layer of a respective one of a plurality of cables, the collar defining a protective area over an overlapped connection between tails of the plurality of terminals to conductors of the plurality of cables, the collar substantially surrounding the shielding layer.

2. The system according to claim 1, wherein the plurality of conductive shields are positioned in a respective one of a plurality of pockets of the housing, wherein each of the plurality of pockets defines a region of air on one or more sides of a respective one of the plurality of conductive shields that affects a dielectric constant of the first connector.

3. The system according to claim 1, wherein each of the plurality of terminals further comprises a contact portion having an end formed of an elbow shape, and each of the plurality of conductive shields comprises a plurality of fingers, wherein the plurality of fingers are configured as an electrically-grounded structure to provide a grounding path.

4. The system according to claim 1, wherein the collar of the plurality of conductive shields is at least one of crimped, welded, and soldered to the respective one of the plurality of cables.

5. The system according to claim 1, wherein the plurality of conductive shields further comprising a plurality of sidewalls having inwardly formed ends having surfaces at which a respective one of the plurality of conductive shields is electrically bonded to a shielding layer of the respective one of the plurality of cables.

6. The system according to claim 1, wherein each of the plurality of conductive shields comprises a plurality of walls having a chicklet positioned therein, the chicklet comprising a protrusion positioned in an opening of a respective one of the plurality of conductive shields.

7. The system according to claim 1, further comprising the second connector that is substantially similar to the first connector, the second connector being configured to couple to the first connector when rotated relative to the first connector at 180 degrees,
wherein the first connector comprises a first engagement feature configured to mate with a corresponding second engagement feature of the second connector; and
wherein the first connector further comprises a second engagement feature configured to mate with a corresponding first engagement feature of the second connector.

8. A connector, comprising:
a hermaphroditic housing;
a plurality of conductive shields; and
a plurality of terminals positioned in the plurality of conductive shields, each terminal among the plurality of terminals comprising a tail,
a plurality of pockets defined in the hermaphroditic housing, wherein the plurality of conductive shields are positioned in a respective one of the plurality of pockets, wherein each of the plurality of pockets defines a region of air on one or more sides of a respective one of the plurality of conductive shields that affects a dielectric constant of the connector
wherein each of the plurality of conductive shields comprises a U-shaped shield and a collar configured to couple to a shielding layer of a respective one of a plurality of cables, the collar defining a protective area over an overlapped connection between the tail of the plurality of terminals and conductors of the plurality of cables, the collar substantially surrounding the shielding layer.

9. The connector according to claim 8, wherein each of the plurality of pockets are defined by four walls of the hermaphroditic housing, wherein the plurality of pockets are aligned in one or more rows in the housing to receive a wafer.

10. The connector according to claim 8, wherein each of the plurality of terminals comprises a contact portion having an end formed in an elbow shape to allow mating terminals to engage each other without stubbing.

11. The connector according to claim 8, wherein the collar is integral with the respective one of the plurality of conductive shields, the collar being crimped, soldered, or connected with a conductive adhesive to a shielding layer of a drain wire of the respective one of the plurality of cables.

12. The connector according to claim 8, wherein the plurality of conductive shields each comprise a plurality of sidewalls having inwardly formed ends having surfaces at which the respective one of the plurality of conductive shields is electrically bonded to a shielding layer of the respective one of the plurality of cables.

13. The connector according to claim 8, wherein the collar comprises an integral indentation and the respective one of the plurality of conductive shields comprises an integral inward protrusion connected to the integral indentation.

14. The connector according to claim 8, wherein:
the respective tail of the plurality of terminals is coupled to a corresponding conductor of the plurality of cables; and
the collar of the respective one of the plurality of conductive shields extends beyond an end of the corresponding conductor to provide a protective canopy over an overlapped connection of the respective tail and the corresponding conductor.

15. The connector according to claim 8, wherein each of the plurality of cables comprises dual, side drain wires, and each of the plurality of conductive shields comprises retaining arms electrically and physically connected to the dual, side drain wires, the retaining arms forming a ground path connection between the respective one of the plurality of conductive shields and a corresponding one of the plurality of cables.

16. The connector according to claim 8, wherein each tail comprises one or more undulated edges having one or more indentations, wherein a width of each tail varies along a connected length to control an impedance of a connection between the tail and the conductor.

17. The connector according to claim 16, wherein each tail comprises one or more peak portions and one or more valley portions, wherein a width of at least one of the valley portions differs from another one of the valley portions, and a width of at least one of the peak portions varies from another one of the peak portions.

18. The connector according to claim 17, wherein one or more of the peak portions are configured to guide a conductor onto the tail, and wherein at least one of the peak portions comprises a hook-shaped portion configured to guide the conductor onto a surface of the tail.

19. The connector according to claim 8, wherein the hermaphroditic housing comprises a first engagement feature and a second engagement feature positioned on opposite sides of the hermaphroditic housing, wherein the first engagement feature comprises a T-shaped rib and the second engagement feature comprises a T-shaped slot.

20. The connector according to claim 8, further comprising a conductive micro-clamp positioned over an opening in at least one of the plurality of conductive shields, the micro-clamp configured to reduce crosstalk and compress dual side drain wires of a cable onto integral tabs of the at least one of the plurality of conductive shields to form a ground path.
